(19) United States
(12) Patent Application Publication
(10) Pub. No.: US 2020/0372918 A1
(43) Pub. Date: Nov. 26, 2020

(54) PLUSH TOY AUDIO CONTROLLER

(71) Applicant: WICKED COOL TOYS HOLDINGS LLC, Bristol, PA (US)

(72) Inventors: Jeremy Padawer, Pacific Palisades, CA (US); Justin Randall Padawer, Salt Lake City, UT (US); Michael Rinzler, Newton, PA (US)

(21) Appl. No.: 16/742,196

(22) Filed: Jan. 14, 2020

Related U.S. Application Data
(60) Provisional application No. 62/851,036, filed on May 21, 2019.

(51) Int. Cl. G10L 17/24; G10L 15/18; G10L 13/07; A63H 3/28

(52) U.S. Cl. CPC G10L 17/24; A63H 3/28; G10L 13/07; G10L 15/1822

(57) ABSTRACT

A master device uses a slave device to connect to the Internet to provide intelligent and dynamic responses. The master device receives input from a user. The master device processes the input and generates a command that is to be transmitted to the slave device via a sound wave. The sound wave is either an audible sound wave or an inaudible sound wave. The command instructs the slave device to perform a certain action and to provide a response back to the master device. The slave device executes the command in response to detecting the sound wave. Subsequent to executing the command, the slave device generates its own sound wave, which includes the response, and transmits the sound wave to the master device. The master device receives the response and tailors another response for the user. The master device then provides the tailored response to the user.

### CROSS-REFERENCE TO RELATED APPLICATIONS

This application claims the benefit of and priority to U.S. Provisional Patent Application Ser. No. 62/851,036, filed May 21, 2019, and entitled “PLUSH TOY AUDIO CONTROLLER,” which is incorporated herein by reference in its entirety.

### BACKGROUND

Communication between devices is possible through numerous wireless interfaces/mechanisms, such as Bluetooth and WiFi. However, these technologies can be expensive and therefore restricted to specific settings, such as tablets, smart devices, and mobile devices. Usually, simple inanimate objects (e.g., toys) are not able to communicate with smart devices because they lack the required communication interfaces. It may also be difficult and/or relatively expensive to equip such devices with the wireless communication interfaces. However, many of these devices are already configured with speakers and are, therefore, capable of producing audible sounds.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

Disclosed embodiments include systems, methods, and devices for enabling a master device, which does not have Internet connectivity (e.g., perhaps because the device has no network interface or perhaps because the master device itself is out of range to receive a direct network signal), to control a slave device, which does have Internet connectivity, to use the slave device's Internet connectivity to provide intelligent and dynamic responses to user input received at the master device.

In some embodiments, the master device detects user input comprising a command that the master device is to perform. This command, however, is of a type that the master device is not able to perform natively (e.g., provide a specific answer to a specific type of user question, where the question is not preprogrammed in the master device) because the master device does not have Internet connectivity or because the master device does not have an Internet interface (or perhaps because the master device does have an interface but is currently out of range for accessing the Internet itself). In response to the user input, the master device parses the user input into a plurality of keywords representative of the command.

The master device also identifies an external device that is able to perform the command (e.g., because the external device, or “slave” device, does have Internet connectivity). The master device determines a sound-based activating phrase that, when detected by a microphone of the external device, activates the external device. The master device concatenates the sound-based activating phrase and the keywords to generate a command phrase. A first soundwave is generated and includes the command phrase. Subsequent to playing the first soundwave over a speaker, which first soundwave triggers the external device to be activated and to provide a response to the keywords in the first soundwave, the master device receives (e.g., from the external device) a second soundwave comprising the response. After parsing the response from the second soundwave, the master device plays a third soundwave over its speaker. This third soundwave includes portions of the response. As a consequence, the third soundwave operates as a particular response to the user input.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

FIG. 1A illustrates an example depiction of a toy that may include any of the features disclosed herein.

FIG. 1B illustrates a computing environment or architecture where an audio controller device (e.g., embedded within a toy) is configured or otherwise structured to communicate with one or more other devices using different sound waves or waveforms.

FIGS. 2A through 2C illustrate various different example scenarios in which an audio controller device is communicating with other devices.

FIGS. 3A through 3E illustrate examples of different flowcharts representing how the audio controller device can operate.

FIG. 4 illustrates a flowchart of an example technique for managing communications between the audio controller device and any number of other devices, including any type of smart device or Internet-of-Things (IoT) device.

FIG. 5 illustrates another flowchart of an example technique for managing communications.

FIG. 6 illustrates how the audio controller device can transmit any type of signal, including audible and/or inaudible signals.

FIG. 7 illustrates another flowchart of an example technique for managing communications.

FIG. 8 illustrates a flowchart for programming the audio controller device.

FIG. 9 illustrates non-limiting examples of toys configured as audio controllers.

FIGS. 10A and 10B illustrate flowcharts of example methods for enabling a master device to control a slave device in order to obtain information from a network (e.g., the Internet).

### DETAILED DESCRIPTION

The disclosed embodiments relate to systems, methods, and devices that provide improved coordination between external sensors or devices (e.g., slave devices) and a master device (e.g., the disclosed audio controller device) to connect the master device to a network.

While a majority of this disclosure will focus on scenarios in which the audio controller device is structured in the form of a child's toy, one will appreciate that the embodiments are not limited only to this type of form factor. Indeed, any physical form may be used, without limit. In some cases, the master device has no network interface (such that it is unable to access the Internet and the device can communicate only by sound) while in other cases the master device is physically located at a position where it currently does not have access to the Internet. In either case, the master device is able to leverage the external slave device to obtain information from the Internet.

Regarding the audio controller device's functionality, the device is able to receive input from a user. This input may be in the form of audio input or even physical input (e.g., push buttons). In response to that input, the device is able to generate an “audible” and/or an “inaudible” sound wave. On average, the human ear cannot hear sounds having frequencies below about 20 Hz and above about 20 KHz. Therefore, as used herein, “inaudible sounds” (aka ultrasonic sounds) are sounds whose frequencies are either below about 20 Hz or above about 20 KHz while “audible sounds” are sounds whose frequencies are between about 20 Hz and 20 KHz. As used herein, the term “(in)audible” refers to an audible sound, an inaudible sound, or potentially a combination of an audible and inaudible sound (e.g., an inaudible sound wave can be superimposed on an audible sound wave).

The device is able to generate an (in)audible sound wave structured to control another device that is capable of detecting sound as input, including sound in the inaudible frequency range and the audible frequency range. By transmitting this (in)audible sound, the device is able to control the external device (potentially) without the user hearing the controlling transmissions. In this regard, the user will be provided with the illusion that the device is the sole operating device as opposed to the device being a master device controlling any number of slave devices in a computing architecture.

As a specific example, suppose the device is in the form of a child's teddy bear. Further suppose a child poses a question to the teddy bear. As will be described in more detail later, the teddy bear is able to receive (e.g., as input) the child's verbal question, process/parse the question, and transmit an (in)audible command to an external device, which is connected to Internet. The (in)audible command can be configured to instruct the external device to obtain an answer to the child's question and to relay the answer back to the teddy bear using another (in)audible sound wave.

Once the external device processes the request and receives the desired answer, the external device can relay that information back to the teddy bear using the (in)audible sound wave. The teddy bear can receive the (in)audible sound wave, process the received information, and provide an answer to the child's question via an audible response from the bear's speakers. In some cases, the audible response can use a preprogrammed voice that has been selected for the teddy bear to communicate with the child. As such, the response can be provided to the child in a familiar voice and from a familiar entity (e.g., the teddy bear) as opposed to some foreign entity (e.g., the external device). Accordingly, the disclosed embodiments are generally related to a computing architecture in which a master device is able to control and communicate back and forth with any number of slave devices to have those slave devices provide tailored responses to input provided at the master device.

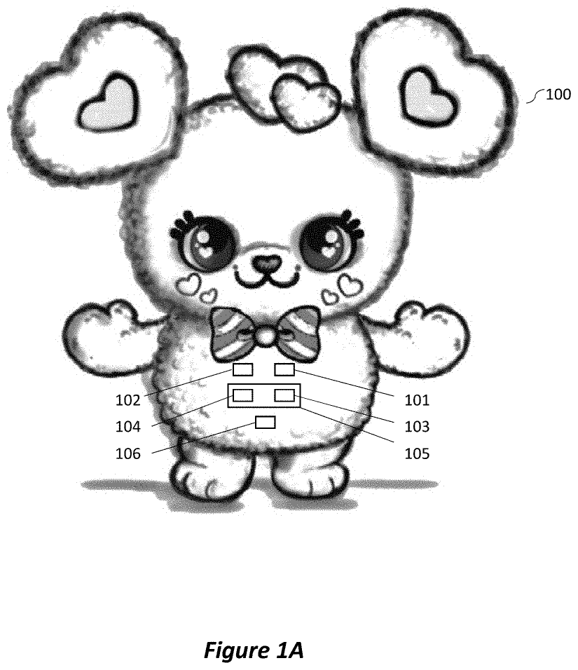

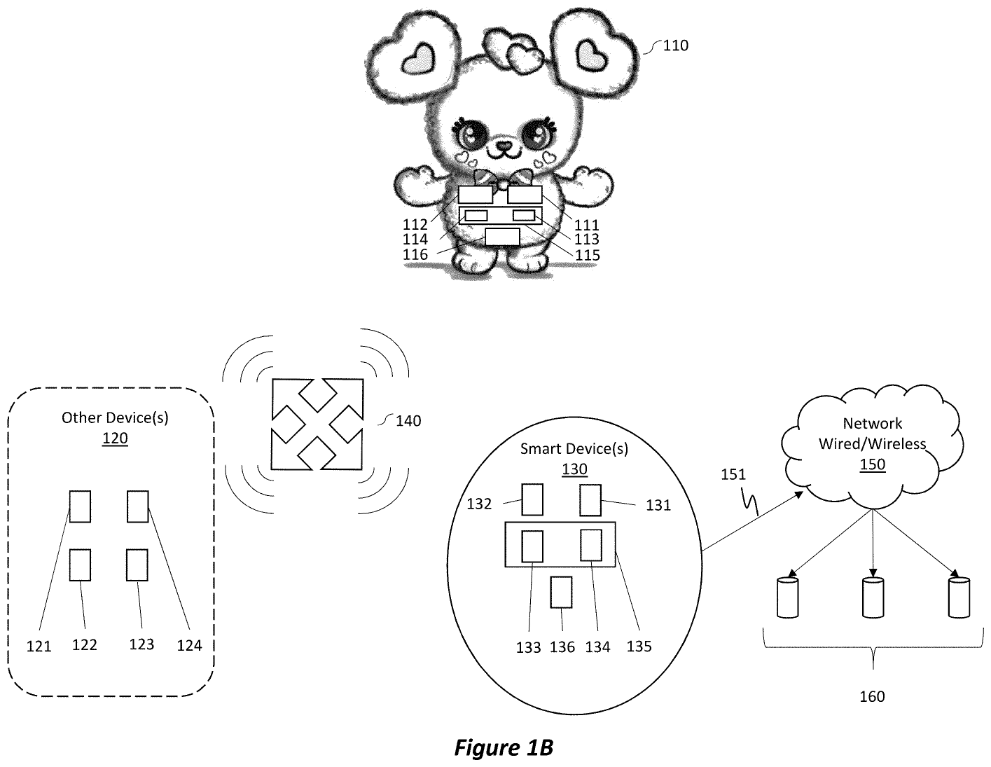

Attention will now be directed to FIG. 1A, which illustrates an interactive toy which comprises an audio controller or device that is configured to communicate with one or more other external devices (e.g., other audio controller devices, smart devices like Alexa, Echo or other devices, or even any type of Internet-of-Things (IoT) device) via soundwaves, to facilitate an unlimited number of programmatic interactive experiences.

As shown, toy 100 includes one or more processors 101 and storage 102 which can store audio files, configuration files (e.g., user controls), wireless connectivity controls, parental restrictions, and/or any type of executable instructions which are configured to implement the functionality described herein when executed by the one or more processors 101. Regarding the parental restrictions, the toy 100 can be pre-programmed to answer only specific classes of questions (e.g., age appropriate questions) and/or to perform only specific types of Internet operations (e.g., age appropriate Internet operations, such as playing child-appropriate music over a speaker).

Storage 102 can store the audio files in any format (e.g., .mp3 format, .wav format, etc.), and the sound produced from executing the audio file can be rendered at any frequency that is detectable by the external smart devices. Toy 100 includes selectable input options (e.g., user interface soft keys) or buttons (e.g., hard keys) that, when selected, enable a user to configure toy 100 in numerous different ways.

In some cases, additional input options are available on toy 100, such as a USB connection, an HDMI connection, a VGA port, an audio port (e.g., for connecting a microphone or a speaker), or any other port. Regardless of which type of input option is used, the user is able to provide input to toy 100.

In some cases, the input is provided to configure the toy 100 while in other cases the input is provided to trigger when the toy 100 is to perform a particular operation, such as by triggering toy 100 to produce a certain sound or to trigger toy 100 to control an external device. The stored audio files are associated with one or more inputs that are detectable by sensors (e.g., the input options) at the device. When an input is detected, the audio file is rendered by one or more device speakers 103 and played either for the user to hear the generated sound waves or for another device to detect the sound waves and to respond to those sound waves in a particular manner, as will be described in more detail later. Of course, the audio files need not be static and instead may be dynamically updated at any time and for any reason.

The device speakers 103 are configured to render/play the audio files according to the attributes associated with the audio files and corresponding with the received/detected user input. By way of example, suppose the left arm of toy 100 includes a depressible or selectable button. In this example, when the button is depressed, the toy 100 is activated or otherwise triggered to produce a particular sound for the user to hear. Additionally, or alternatively, another inaudible sound may be produced, where this inaudible sound is detectable by another device, and the inaudible sound can be structured, formatted, or otherwise tailored to control the other device in some manner, as will be described in more detail later.

Microphone 104 is an example of a sensor that can detect audible or inaudible sound waves. In some implementations, the microphone 104 is structured as one of the input options or devices mentioned above. As such, microphone 104 can be configured to receive different types of sound input in order to facilitate the control of toy 100.

Transceiver 105 can include or be connected to the speakers 103 and/or the microphone 104. Transceiver 105 can receive or transmit any type of signal, including sound waves, radio waves, and so forth.

Toy 100, also referred to as a “device,” an “audio controller,” or an “audio controller device,” can have any of the foregoing components positioned at different places on or within the device. Toy 100 can also include one or more user interface components 106 which are configured to receive and/or process user input and/or to provide output. The one or more user interface components 106 may be hard key buttons or may include soft keys displayed on a touch-sensitive display screen.

In some instances, the user interface components 106 include one or more sensors that can detect light, audio, touch, or pressure. In some cases, other sensors may be included, where these other sensors relay information from the user or environment. The relayed information can be detectable with the one or more processors that are connected to the sensors. The input detected by the sensors is used, in some instances, to trigger the communication of control information as audio soundwaves that are transmitted by the device to another device, such as a smart device.

In some instances, the user interface components 106 can also provide output components that provide output in the form of haptic, visual, audible, mechanical, or other feedback that corresponds to the audio commands.

FIG. 1B illustrates a computing environment in which an interactive toy comprises an audio controller or device that is configured to communicate with one or more other external devices (e.g., other audio controller devices, smart devices like Alexa, Echo, laptops, desktops, servers, mobile phones, smart sensors, or other devices) via soundwaves, to facilitate interactive experiences.

Toy 110 is another toy/device that is similarly configured to the toy 100 from FIG. 1A, with one or more processors 111, storage 112, speakers 113, microphones 114, transceivers 115, or user interface components 116. Toy 110, in some instances, can be referred to as a “master” device, similar to toy 100 from FIG. 1A.

Device 120 is an example of an external device (which can be a smart device) with which the toy 100/110 can interact using soundwaves (audible and/or inaudible signals). With reference to the earlier example, toy 110 (or toy 100) is an example of a master device while device 120 is an example of a slave device controllable by the master device. In accordance with the disclosed embodiments, the master device is able to control the slave device using at least sound waves, though other control techniques are available as well (e.g., radio communication control).

Device 120 also includes one or more processor(s) 121, storage 122, and a transceiver 123, which includes and/or is connected to one or more microphones or speakers. Device 120 also includes one or more other user interface sensors/components 124, such as, but not limited to, haptic, visual, audio, tactile and/or other components. Device 120 may be configured to communicate with one or more remote devices (e.g., Internet server devices) to gather and render information from the remote devices.

Similar to the device 120, smart device 130 (i.e. another example of an external device) is configured to communicate with one or more remote devices (e.g., Internet server devices) to gather and render information from the remote devices. In some instances, the smart device 130 comprises a smart phone, an Alexa ® device, an Echo Dot ® device, a Google Home ® device, a smart TV, a laptop, a gaming system, an IoT (internet of things) device, and/or another smart device.

The smart device 130 includes one or more processors 131 and one or more storage 132 that stores computer-executable instructions that are executed by the one or more processors 131 to implement the disclosed functionality.

In some instances, the smart device 130 includes a speaker 133 capable of producing both audible and inaudible sounds, a microphone 134 capable of detecting audible or inaudible signals and inputs from the users or even from the toy 110, a transceiver 135, and user interface components 136.

Device 130 communicates with one or more remote devices 160 (e.g., Internet servers or other network servers/devices) through any combination of wired and/or wireless network(s) 150 as shown by communications 151.

In some instances, the smart device 130 includes functionality for not only receiving (in)audible signals but also for responding to those (in)audible signals, which may be received as soundwaves from the toys 100/110 by identifying control instructions associated with the soundwaves.

In some instances, the smart device 130 receives audio control data in an analog sound waveform/signal, which has an auditory signature or pattern. The audio control data may be transmitted in either an audible sound wave or an inaudible sound wave. The smart device identifies this pattern and identifies one or more instructions/controls associated with the pattern/signature, based on stored mappings between them at the smart device and/or remote devices 160.

In some instances, the smart device 130 identifies the signature or pattern by translating the analog waveform into a digital format and/or by parsing the data in the waveform (e.g., using a sound to text translator) to identify/reveal the signature/pattern and/or other metadata associated with the received audio data. The metadata may identify the device, and/or a control instruction based on user input detected at the device, as described above.

In some instances, the smart device will look up the signature or pattern in a table or other data structure stored at the smart device. In other instances, the smart device provides the pattern/signature to the remote devices 160 as a query input for looking up control information and/or for triggering a function that is initiated by the smart device and/or remote devices and/or that can be communicated back to the device 100/110 to trigger functionality at the device 100/110.

Signal symbol 140 is an illustration of the communications between the devices through sounds waves, whether they are audible or inaudible. Each device will have the capability to communicate through one of the devices displayed in this computing environment individually or in tandem, without having to rely on Bluetooth, WiFi, or other standardized wireless protocols (other than simple soundwaves).

As will be described in more detail later, some embodiments are able to embed ultrasonic tones or sounds into an audible signal and then subsequently play back that combined signal. A human user will be able to hear the audible portion of the combined signal while a monitoring device (e.g., the disclosed external devices) will be able to detect both the audible signal component and the ultrasonic/inaudible signal component. The external device is able to differentiate the frequencies between the two signal components, and parse the signals from the combined signal. Once parsed, the external device can selectively ignore the audible signal component (e.g., because the audible signal component was likely provided for the user to hear) and selectively respond only to the ultrasonic signal component.

As described earlier, the devices are able to communicate using soundwaves within the audible range of the human ear (e.g., 20 Hz to 20 KHz) and/or an inaudible range above 20 KHz and/or a range below 20 Hz (e.g., the ultrasonic range). Selecting which sound wave range to operate may be dependent on a number of factors, including the device, the corresponding user input associated with the audio files, environments or other contexts in which the audio files are rendered, user settings, or even user input received at the toy 110.

In some instances, different devices are configured to process sound waves having different frequencies. For example, one device might communicate using sound waves within the range from 100 Hz to 15 KHz, while another will use 10 Hz to 10 KHz. In some cases, a command issued by toy 110 may be provided using one frequency (or within one frequency range), and the response generated by the smart device 130 may be provided in the same frequency (or frequency range). Alternatively, the smart device 130 may elect to use a different frequency for its response so as to differentiate commands provided by the toy 110 from responses provided by the smart device 130.

In some cases, the toy 110 may issue commands in the lower inaudible frequency range (e.g., less than about 20 Hz) while the smart device 130 may issue responses in the upper inaudible frequency range (e.g., more than about 20 KHz). Other embodiments may switch the two ranges. In some cases, a range of frequencies may be selected or designated for the toy 110 to operate with while a same or a different range of frequencies may be selected or designated for the external device to operate with.

It will be appreciated that one advantage of using soundwaves to communicate between the devices is that it is not necessary to configure each device with WiFi communications equipment and/or to program/provide each device with WiFi credentials in order to enable the device/toy to access the Internet and other functionality provided by a smart device that the toy can communicate with. That is, the master device (i.e. the toy 110) can access the Internet (e.g., via the slave devices) even though the master device may not have an interface for directly communicating or accessing the Internet.

For example, a child can now bring their toy with them to another friend's house and the toy (by playing a prerecorded audio file) can have the capability to control/operate an external device (e.g., an Echo Dot) in a new location without having to have the WiFi/network credentials known by the external device. That is, because the Echo Dot already has an Internet connection and because the Echo Dot is configured to awaken in response to a predetermined triggering command (e.g., by saying “Alexa” the Echo Dot can be triggered to listen for input), the toy can obtain access to the Internet via the Echo Dot (i.e. the toy can utilize the Echo Dot's Internet interface) by simply providing a command starting with the triggering term or phrase (e.g., “Alexa”). To clarify, the toy can access the Internet without having a direct Internet connection or a direct connection with a network.

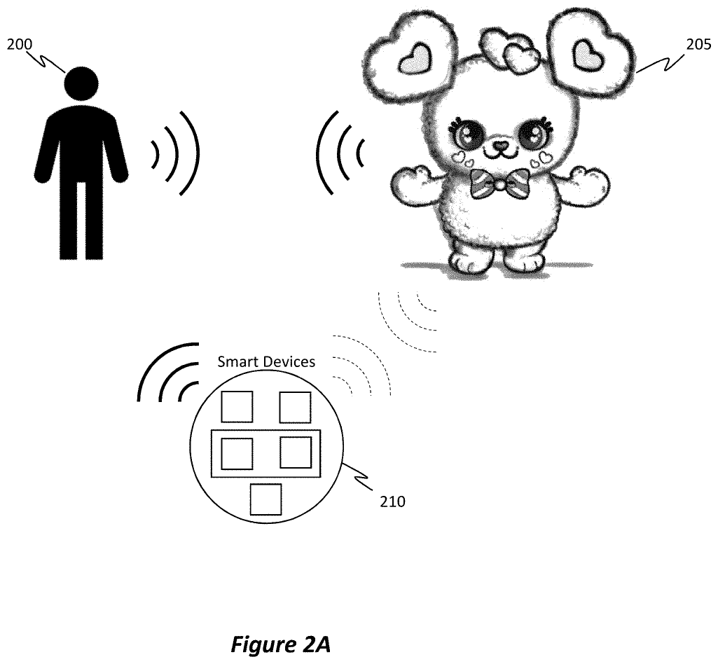

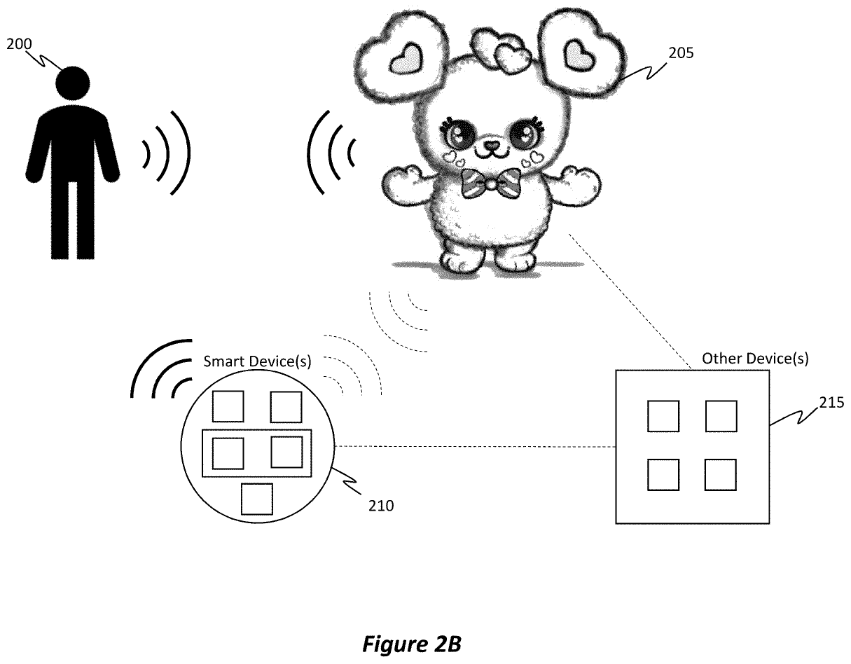

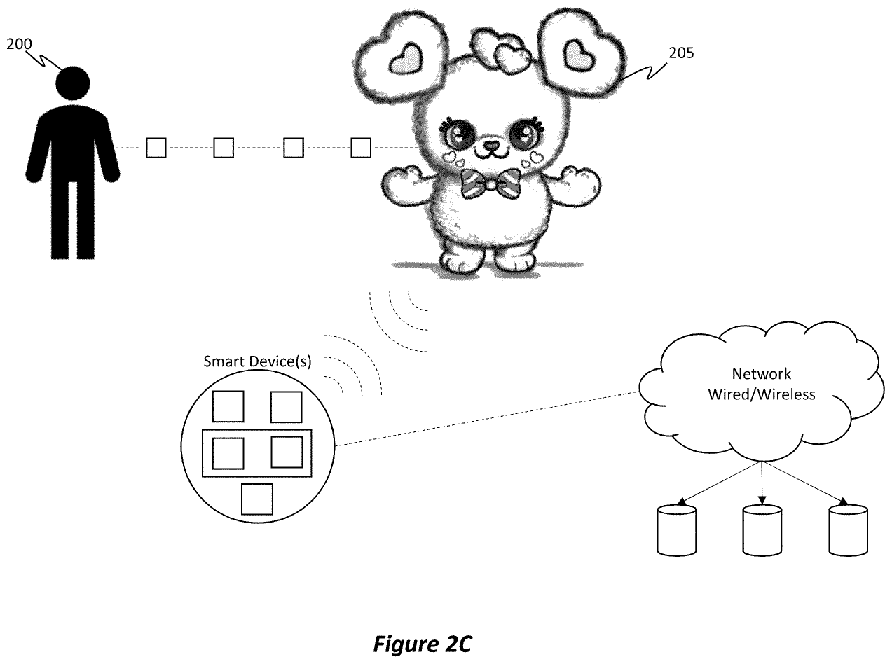

FIGS. 2A through 2C illustrate a practical example in which the disclosed embodiments may be practiced. Specifically, FIG. 2A illustrates a user 200 (e.g., perhaps a child) speaking to the toy 205, which is representative of the toys and master devices discussed thus far. User 200 may be commanding toy 205 to answer a question user 200 has. Because toy 205 does not have a direct Internet connection, toy 205 may not be able to provide a response to the question without assistance. As such, toy 205 generates a sound wave that is to be transmitted to an external device 210, which does have an Internet connection and which is able to respond to sound wave commands (either audible or inaudible).

In particular, toy 205 is able to receive the verbal input command provided by the user 200. The toy 205 can then detect a type of the external device 210 to determine which keywords are required to activate the external device 210. In some cases, these keywords can be stored in internal memory of the toy 205. Some of the types of external devices were listed earlier and include, but are not limited to, the Echo Dot and others. In order to activate these devices, a keyword or phrase is often required (e.g., “Alexa” or “Siri,” and so forth).

The type of the external device 210 can be determined in any number of ways. For instance, a ping can be sent from the toy 205 directly to any listening devices to inquire as to their types. In some cases, a ping can be sent to a network router to inquire from the router which devices are present in the toy 205's environment (e.g., if the toy 205 includes wireless abilities). In some cases, the toy 205 can issue a verbal challenge or question to the user 200 to ask the user 200 if there are any Internet connected devices in the immediate environment. Based on a response from any one of these inquiries, the toy 205 is able to determine which type of external device it is to communicate with.

When multiple Internet-connected devices are present in the environment, the toy 205 can select a specific one of those devices. This selection may be based on a proximity requirement. For instance, the device being most proximate in terms of distance to the toy 205 may be best suited to listen to the sound wave that will be produced by the toy 205. In some cases, the device with the most remaining battery life may be selected. In some cases, the device with the most so-called “intelligence” may be selected. For instance, a smart thermostat may be connected to the Internet, but the smart thermostat may be limited in its communication abilities or in its abilities to query the Internet. In contrast, the Echo Dot or even a user's smart phone may have enhanced abilities for navigating and searching the Internet. As such, the toy 205 can select its slave device based on determined characteristics of that slave device.

Once the type of the slave device is determined, the toy 205 then selectively parses the command received from the user 200. By way of example, the toy 205 is able to convert the command from speech to text. The text can then be analyzed to identify key terms, determine its semantic meaning, and determine the type of command (e.g., a declarative statement, an interrogatory statement, and so forth). Once any key terms and the semantics are determined, the toy 205 can generate its own command phrase. Additionally, the toy 205 can append the external device 210's activating phrase to the generated command phrase. Often, the activating phrase will be appended at the beginning of the command phrase.

In some cases, a determined time delay may be introduced into the command phrase. For example, the command phrase may comprise a plurality of parts or sections, including an activating section, a command section, and a closing section. The activating section may include the activating phrase of the external device 210 (e.g., “Alexa” or “Siri”). This activating phrase, when issued, wakes up the external device 210.

The command section may include a command prepared by the toy 205. The command section can include some of the keywords that were originally extracted from the user 200's speech.

Finally, the closing section may include any closing remarks or commands that may be included in the command phase. In between any one or all of these different sections, the embodiments can introduce a designated time delay. The time delay can be set to any duration. Example durations include, but are not limited to, 0.25 seconds, 0.5 seconds, 0.75 seconds, 1.0 seconds, 1.25 seconds, 1.5 seconds, 1.75 seconds, 2.0 seconds, 3.0 seconds, 4.0 seconds, 5.0 seconds, and so forth. The time delay may be used to allow sufficient time for the external device 210 to wake up in response to the activating command so the external device 210 can then receive subsequent commands.

Once the command phrase (including the external device 210's activating phrase) is generated (e.g., in text form), the toy 205 can perform a text to speech operation. That is, the text can be converted to a sound wave. As described throughout this disclosure, the frequencies of this sound wave may be in the audible range or, alternatively, in the inaudible range. In some cases, the sound wave may be a composite sound wave that includes frequencies in both the audible range and the inaudible ultrasonic range. In some cases, the inaudible portion of the command is superimposed over the audible portion such that, when the sound wave is actually played, both the audible portion and the inaudible portion are played during a concurrent or simultaneous time period. In some cases, the inaudible portion can precede or follow the audible portion. One will appreciate how different configurations are available. Once converted, the sound wave can be played over a speaker of the toy 205.

The external device 210, upon detecting the activating command, can then listen for the command provided by the toy 205. Similar to how the toy 205 operated, the external device 210 can also parse the command to identify key terms and semantics and can perform voice to text to generate a text file or command. Any noise filtering may also be performed to improve the quality of the received signal.

Using the parsed key terms and semantics, the external device 210 can then query the Internet for a response to the command (e.g., by submitting a text command). Once a response is generated, the external device 210 can perform text to voice and can generate its own sound wave to transmit that sound wave back to the toy 205.

Once the toy 205 receives the response from the external device 210, the toy 205 can again parse the response to identify key terms and semantics. The toy 205 can then generate its own response based on the response received from the external device 210. In some cases, the response of the toy 205 may be the same as the response generated by the external device 210 while in other cases the response of the toy 205 may be different (though related) to the response generated by the external device 210. The toy 205 can then audibly play its response so the user 200 can finally hear a response to his/her initial command or request. Of course, these processes may be performed very quickly (e.g., less than a second or perhaps a few seconds) so the user 200 will not be waiting long to hear a response.

In some cases, the toy 205 can playback a song or can playback a message to allow the user 200 to know that the toy 205 is actively operating in response to the user 200's request. That is, feedback can be provided by the toy 205 to let the user 200 know the toy 205 is actively processing the user 200's request. By providing a message while the operations are being performed, the user 200 will know that his/her command is being processed, and the user will not be concerned that the toy 205 is not operating or is malfunctioning.

FIG. 2B illustrates an alternative scenario in which an intermediate or proxy device 215 facilitates communications between the toy 205 and the external device 210. That is, instead of the toy 205 directly communicating with the external device 210, the toy 205 may instead communicate directly with a secondary device 215. The secondary device 215 may then pass on or forward the request from the toy 205 to the external device 210 for processing in the manner described earlier. Similarly, the secondary device 215 can receive the response from the external device 210 and relay that response back to the toy 205.

FIG. 2C shows how any number of voice transmissions can be communicated from the user 200 to the toy 205. In some cases, the user 200 may provide an extended number or length of commands, as represented by the squares being transmitted between the user 200 and the toy 205. In some cases, the toy 205 may include a buffer or perhaps a queue that is configured to temporarily store the input received from the user 200. After the user 200 is finished, or perhaps while the user 200 is still speaking, the toy 205 can send commands to the external device.

That is, in some embodiments, toy 205 will wait to communicate with the external device until the user 200 is done speaking and issuing commands. In other embodiments, the toy 205 is able to selectively issue periodic commands to the external device even while the user 200 is still speaking. In some cases, based on the context of the user 200's dialogue, the toy 205 is able to predict or estimate (e.g., perhaps using machine learning or other smart features) a context the user 200 is discussing. Based on this predicted context, the toy 205 can preemptively issue a command to the external device.

The command can be a predicted command that the toy 205 predicts the user 200 is hinting at, alluding to, or even will speak. In this regard, the toy 205 can initiate the process of obtaining a response to the user 200's dialogue even before the user 200 has finished speaking. Because the toy 205 is able to communicate with the external device in an inaudible manner, the user 200 will not be aware of these background communications.

If the response from the external device is received by the toy 205 before the user 200 is finished speaking and if the response accurately corresponds to the user 200's final end dialogue, then the toy 205 can provide the response to the user 200 almost immediately after the user 200 has finished speaking such that the user 200 perceives little to no delay or latency in between when the user 200 finishes speaking and when the toy 205 responds.

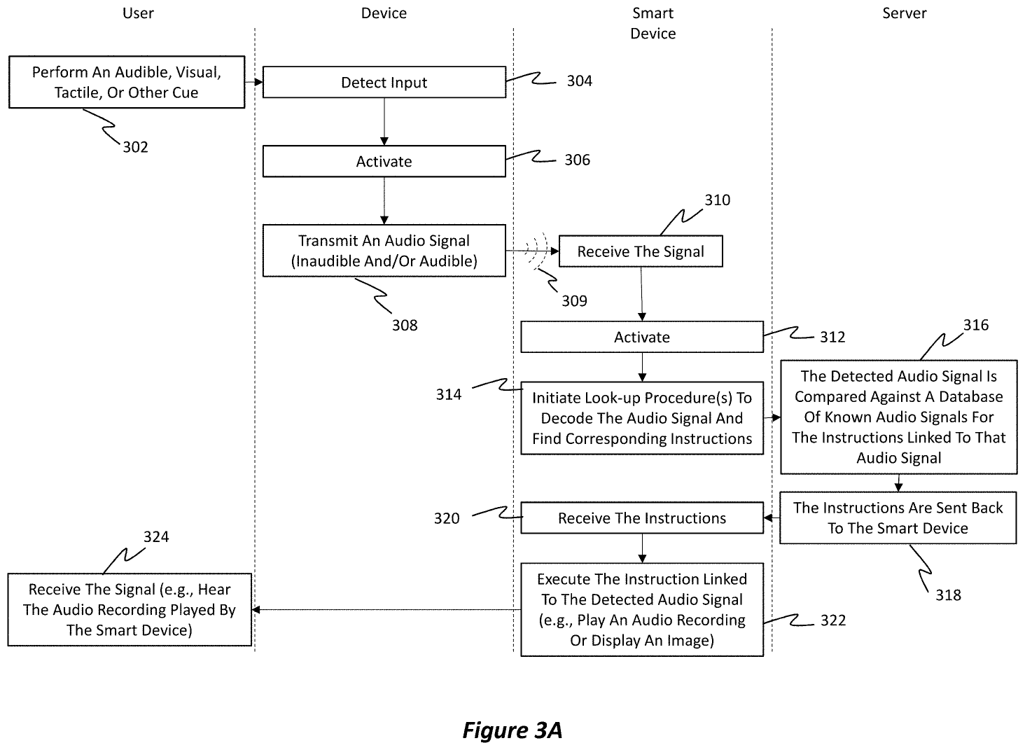

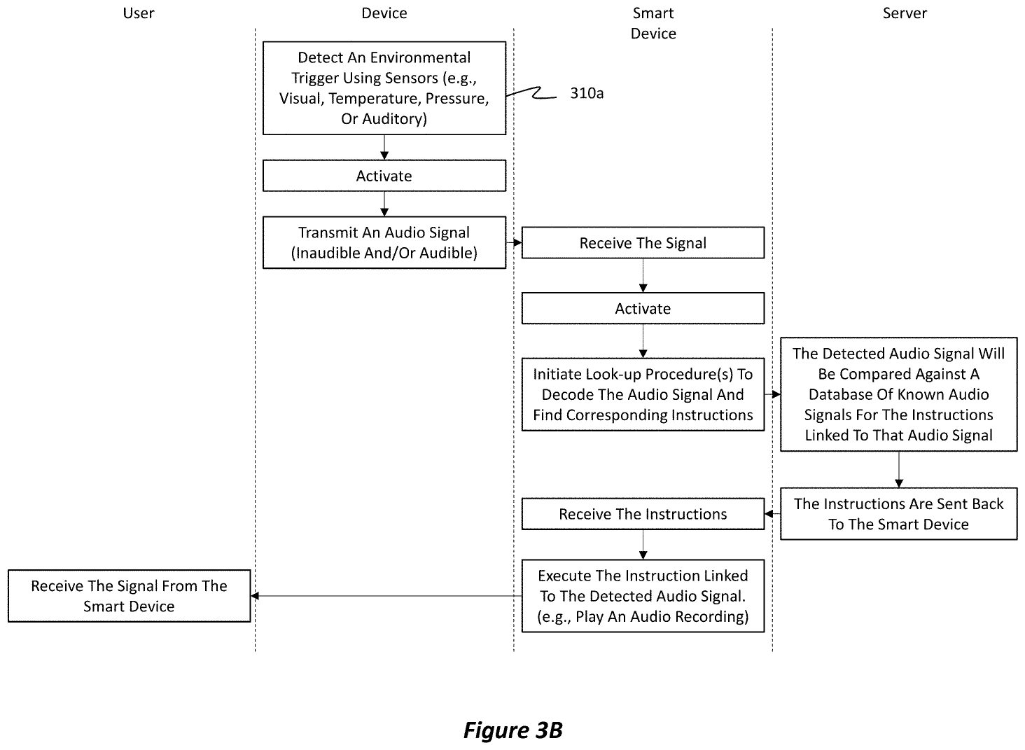

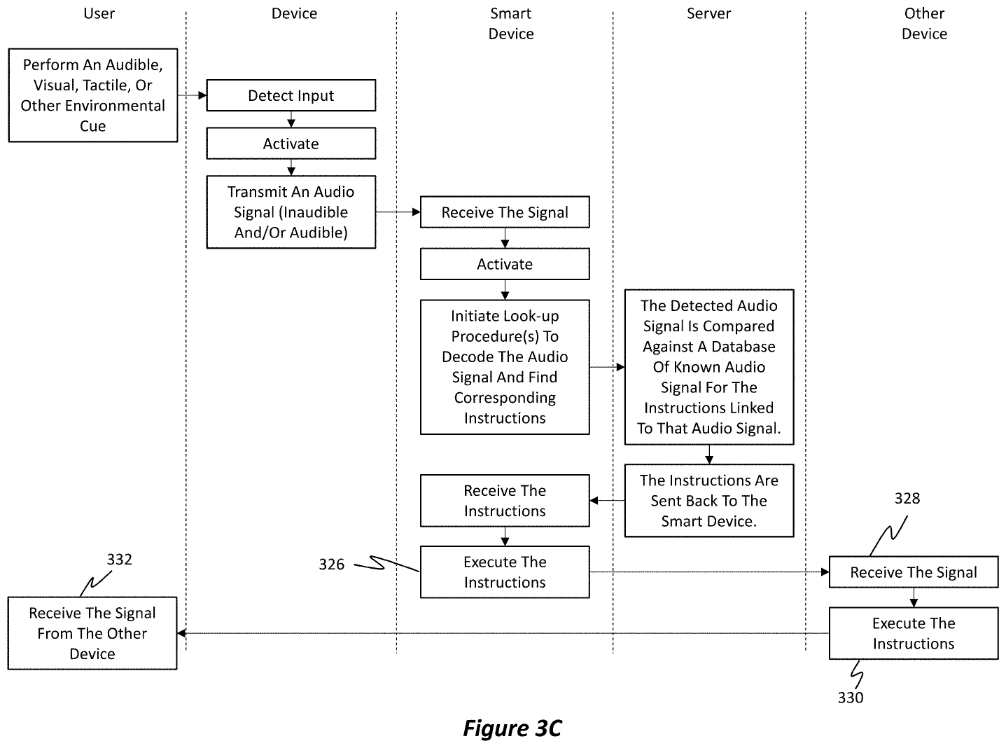

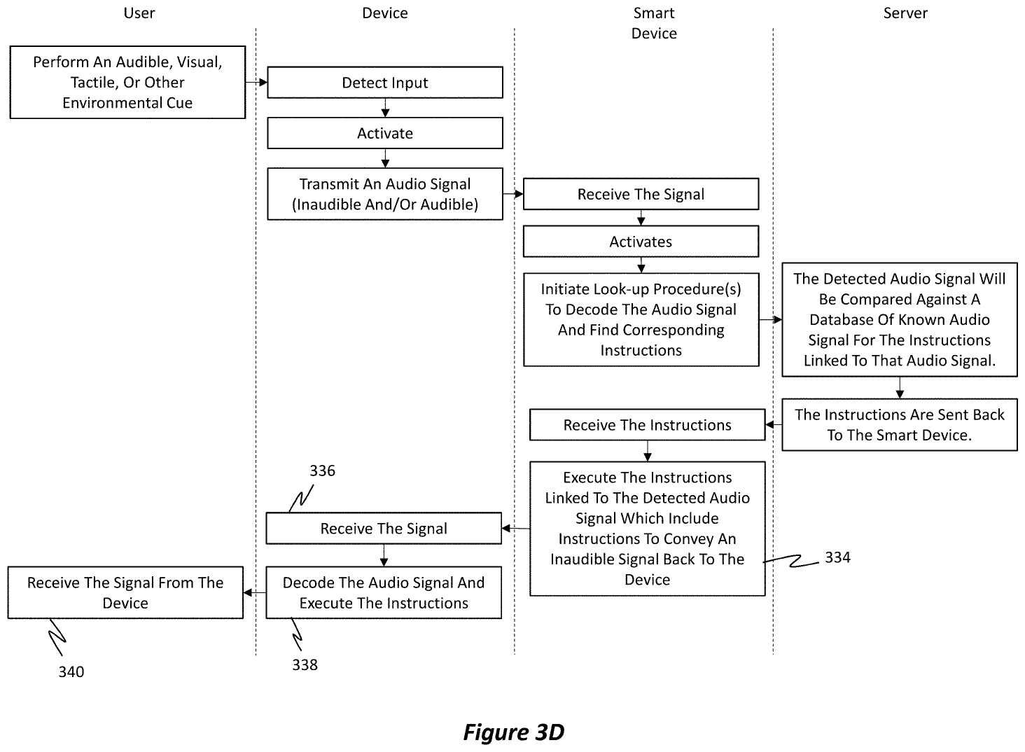

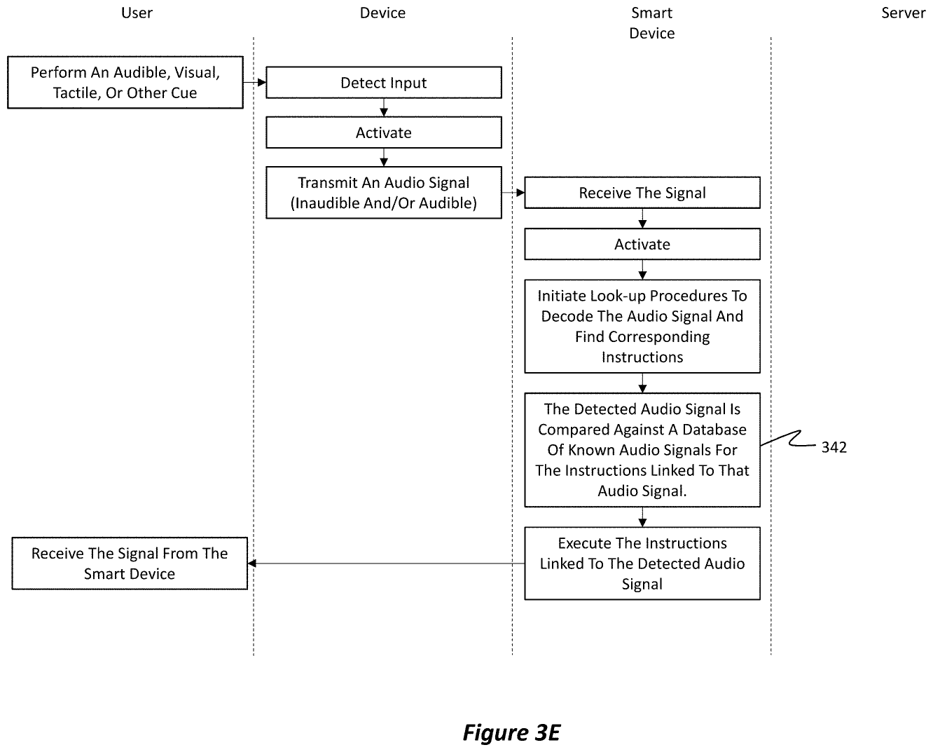

Attention will now be directed to FIGS. 3A through 3E. These Figures illustrate various flowcharts of example methods, techniques, or processes that may be performed. These Figures also illustrate different operations or acts that may be performed by different respective entities, including a user, an audio controller device (e.g., device) (aka the toy), a smart device (e.g., an external device), and the Internet (e.g., by way of an Internet Server).

As illustrated in FIG. 3A, a device is configured with a processor and storage chip with pre-embedded sounds, both audible and inaudible. This device is representative of the master devices, audio controller devices, and toy described throughout this disclosure. One will appreciate how these flow diagrams are illustrated as discrete steps that may potentially be performed one after another in a particular order (if so specified).

Prior to any input from the user, the device remains inactive. When the user performs an action (e.g., act 302), the device will detect the user input (act 304), which will result in the device becoming active (act 306), after which the device emits a sound (act 308), which is an audio signal 309. The audio signal communicates information about the device to the appliance, or rather the smart device. The audio signal will be detected (e.g., act 310) by the internet appliance or smart device (like an Echo) and activates the internet appliance or smart device (act 312). The internet appliance or smart device will contact a server subsequent to decoding the audio signal and executing instructions on how to proceed (act 314), over a wired or wireless connection, to access a database of pre-recorded audio signals which are paired with instructions (act 316). The smart device will utilize the access to the database to compare the audio signal received from the device to a list of known audio signals, to find a set of instructions that are paired with that specific audio signal, which instructions are then sent back to the smart device (act 318). After the smart device has recovered the instructions paired with the audio signal (act 320), the appliance/smart device executes the instructions (act 322) and provides output (act 324). The output (received at act 324) from the smart device can be audible, visual, tactile, or another response.

In another embodiment, a user provides input to the toy by speaking to it, pushing on the toy's tummy, or hugging the toy. Additionally, or alternatively, the user can provide input by manipulating a touchscreen that is included as a part of the toy. Regardless of how the input is received by the toy, the toy is able to receive and process the input in the manner described earlier (e.g., parse and/or append commands or command strings together).

The sensors and microphones in the toy detect the input and use a speaker to transmit an audible or inaudible signal to smart device which will then look up a response in the storage of the smart device or in a database accessed through the cloud. Afterward, the smart device relays information back to the user, through visual, audible, or other feedback. For example, the smart device might recognize the toy is being hugged through pressure and touch sensors and respond, “teddy loves hugs.”

In another example, a user (e.g. a child) pushes a plush stomach of the toy. In response, the toy emits audible or inaudible sound from its speaker, which may be controlled by an integrated circuit (IC), processor, or other hardware logical unit. In response to the audio, an external device (e.g., an “Alexa” smart device) detects the sound, identifies the toy based on the sound, and triggers the rendering of a stored audio file associated with the toy's stored IC to produce a sound which says, “Good to see you Licky Dog.” Later, the child pushes the plush stomach again and/or harder. The toy, responsively, emits an (in)audible sound or tone that is interpreted by Alexa to trigger Alexa to play a file that says, “I'm sorry you're sad Licky Dog.” Additionally, or alternatively, if the child questioned the bear, the bear can control the Alexa device to provide an answer to the child's question.

The device can be programmed with any quantity of prerecorded interactions/sound files, to render audio at the device in response to a detected user input at the device (tactile or audible) and/or to trigger a functionality at the device in response to an audio rendered by the smart device and that is detected by the device. The device may also be programed with randomized responses, such that a single action may result in more than one response. Further, the device may have more than one response to the user input such that in addition to transmitting an audio signal, the device also has a response which is not audio such as visual, tactile, haptic, or perhaps another response. In addition, the communication mechanism from the device to the smart device could be something other than an audio signal such as Bluetooth, infra-red, Wi-Fi, radio, or another communication mechanism.

In another embodiment, illustrated in FIG. 3B, the toy will respond to the environment and use the smart device to generate the predetermined response. The toy will detect a change in light, sounds, or touch through one of its visual, audio, or tactile sensors (act 310a). At which point, the process will proceed as similarly described in FIG. 3A. For brevity purposes, the labels from FIG. 3A have not been repeated in FIG. 3B. One will appreciate, however, that like elements in FIG. 3B correspond to like elements in FIG. 3A.

For example, in response to lights being turned off in the room, the toy will emit an audio signal which will be detected and interpreted by the smart device, and the smart device will respond with output for the user such as snoring noises or by explaining “teddy is scared” or even by responding to an inquiry posed by the child.

In another example, the toy can be supplied with sensors and programming to detect that a baby is crying (e.g., with its microphone sensors or perhaps in response to an alert provided from an external device that detected the crying condition) and will communicate back to the smart device (via a different audio signal, e.g., “Alexa play a song”) to instruct the smart device to play calming music or white noise and/or to send a notification to an interested guardian device. To clarify, in some embodiments, the toy can instruct the external device to send a message to an interested party (e.g., a parent). Examples of messages include, but are not limited to, SMS text messages, email messages, instant messages, and so forth.

As indicated above, in some cases, the toy can initially receive alerts from an external device (e.g., an alert indicating an infant is crying). That alert may include data describing the current condition which triggered the external device to provide the alert. The toy is able to receive and process the information and determine how to respond to the condition based on the details provided in the alert. For instance, with the example from above, an external device may alert the toy that an infant is crying. In response, the toy can begin playing a soothing lullaby or some other comforting sound or music. In other cases, the toy can detect the crying condition and instruct the external device to perform some action.

In another embodiment, illustrated in FIG. 3C, after proceeding similarly to the embodiments described in either FIG. 3A or 3B (again, like elements have not been relabeled for brevity purposes), the smart device sends a communication signal (act 326), which is received at another device (act 328), based on identifying a control/functionality associated with the audio signal it detected from the toy. The communication signal sent from the smart device to the other device has executable instructions for the other device to execute (act 330).

For example, when a user squeezes the left paw of the toy, it will result in an audio signal being sent from the toy to a smart device which corresponds to a set of instructions for the smart device, which includes instructions to forward the instructions to a smart light device. The smart light device will execute the instructions which may include turning off the lights. Therefore, the user has the capability to turn off the bedroom lights through the toy or audio controller.

The embodiment demonstrated in FIG. 3C may also include a capability for the smart device to send a signal to multiple other devices (e.g., as described in act 326). An instruction set executed by the smart device may include communication and instructions for multiple other devices. In addition, the instruction set may include instructions for the smart device to perform in addition to instructions to be forwarded to another device. For example, the instruction set might instruct the smart device to play bedtime music while simultaneously forwarding instructions to a smart light device to turn off the lights. In some cases, feedback may be provided to the user regarding the actions the various devices have performed. For instance, the user may receive or hear a signal provided by any of the other devices (act 332).

In another embodiment, illustrated in FIG. 3D, after proceeding similarly to the embodiments described in either FIG. 3A or 3B, the smart device sends an audio signal (act 334) back to the device, which receives the signal (act 336), based on identifying a control/functionality associated with the audio signal it detected from the toy. The communication signal sent from the smart device to the device has instruction for the device to execute (act 338). For example, when a user squeezes the left paw of the toy, an audio signal may be sent from the toy to a smart device which corresponds to a set of instructions for the smart device to forward the instructions to the toy. The toy will light up in response (act 338). In some cases, the user can receive or hear the signals produced by the devices (act 340).

In another embodiment, illustrated in FIG. 3E, the smart device (e.g., perhaps at some point between acts 314 and 334) will access a database (act 342) located in the storage of the smart device to look up a set of instructions paired to known audio signals.

For example, in response to a hug, the smart device may instruct the toy to light up, speak through a microphone, or respond with mechanical movement or haptic feedback for the user. Further, the smart device can relay an auditory signal back to the toy and instruct it to light up, or speak to the user, or provide some other feedback or combination of feedback.

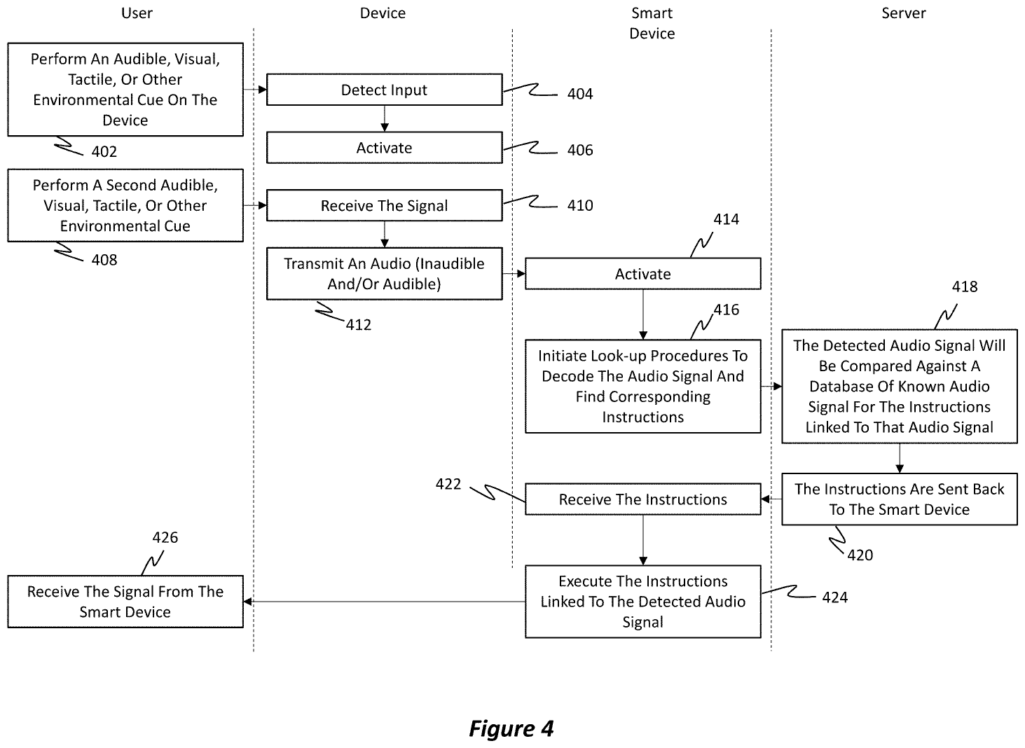

In another embodiment, illustrated in FIG. 4, the user performs an action (act 402), and the toy will detect the input (act 404) and activate (act 406). After which, the user performs a second action (act 408) which will be detected by the toy (act 410). Subsequently, the toy will emit an audio signal which can be audible sound, inaudible sound, or both (act 412). The audio signal will be detected by a smart device (act 414), which will cause the smart device to become active (act 416) and initiate a look-up procedure. The smart device will decode the audio signal by comparing the received signal against a database of pre-recorded audio signals (act 418). The detected audio signal will be paired with a set of instructions for the smart device, which are sent back to the smart device (act 420). That is, the smart device receives the instructions (act 422). The smart device will then execute the instructions (act 424) which include output for the user (act 426).

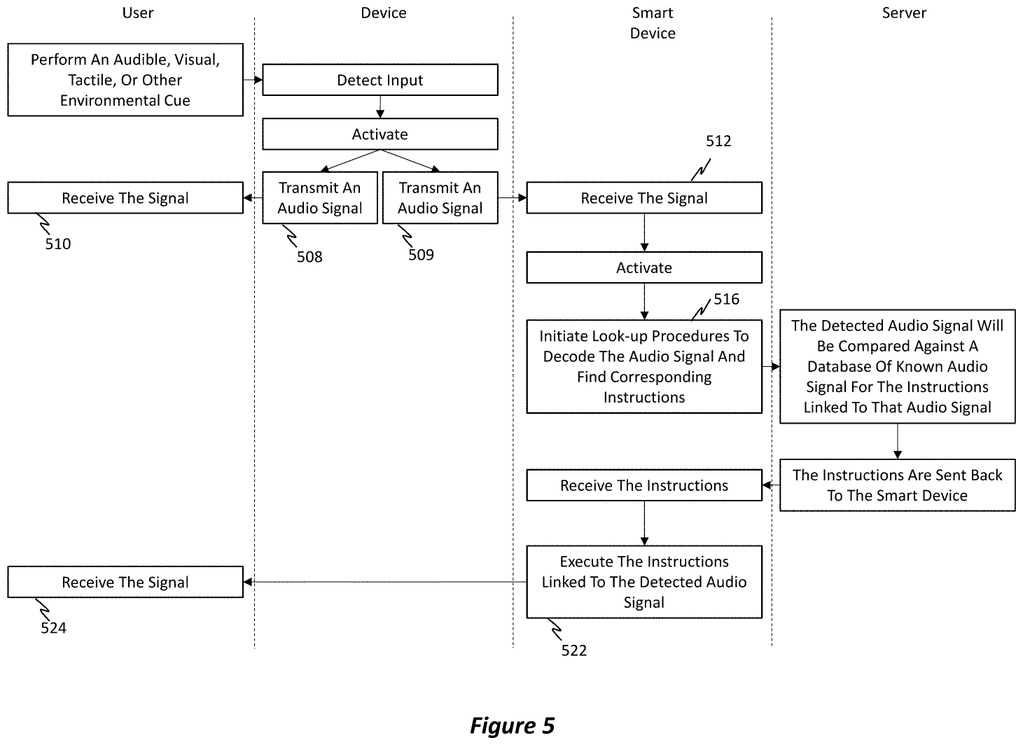

FIG. 5 illustrates some additional operations that may be performed in addition to the operations described in FIG. 4. For instance, subsequent to the device activating (e.g., act 406 in FIG. 4), the audio controller/toy will simultaneously emit two sounds, including an audible sound (act 508) (e.g., by playing an audio file) for the user to hear (act 510) (e.g., an unintelligible animal sound) and an inaudible sound (act 509) (e.g., a second audio file that is rendered at a different frequency that is inaudible to a human, such as below 20 Hz or above 20 KHz). The second sound may be an audio signal and may be detected (act 512) and interpreted (act 516) by the smart device to trigger functionality (act 522) by the smart device.

The smart device identifies the control information, or instructions, associated with the audio signal(s), by identifying a pattern with the audio signal(s), from a referenced database of signals and executing the control information, or instructions, which include output as a corresponding response to the user (act 524). For example, the toy's audible signal might be gibberish or in a foreign language. However, the smart device may interpret the inaudible signal to trigger a translation or associated intelligible rendering of the gibberish that is rendered by the smart device.

Referring back to FIG. 1B, in another embodiment, it is possible for a first toy (e.g., perhaps toy 100 from FIG. 1A) to communicate with the second toy 110 using audible or inaudible sound waves by sending messages using the speaker 103 which is then detected by the microphone 114 on the second toy 110 and interpreted using the processor 111, and the storage 112 to generate predetermined response/functionality at the second toy 110, based on a mapping of the audio signature associated with the audio messages and that are stored at the second toy 110.

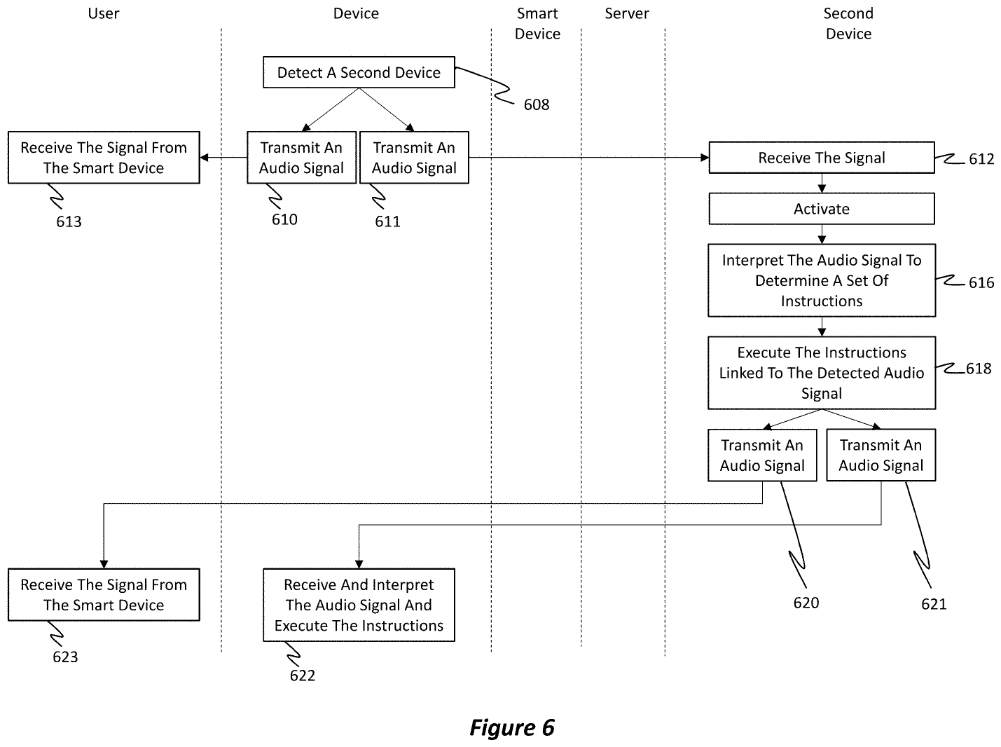

An example of such a process is further illustrated in FIG. 6. A first device (e.g., perhaps toy 100 from FIG. 1A) will recognize that a second device (e.g., perhaps toy 110 from FIG. 1B) is within a certain proximity (act 608). After the first device has determined that a second device is nearby, it will emit an audio signal (act 611) which will be detected by the second device (act 612). The second device will interpret the audio signal (act 616) and execute the instructions (act 618) corresponding to the audio signal that was received from the first device which may include emitting another audio signal (act 621) to be detected and interpreted (act 622) by the first device. The first device can optionally continue the interaction between the first and second device or terminate the interaction.

In one embodiment, the first and second device will emit two simultaneous sounds. The first device, after having determined that a second device is nearby (as described in act 608), will emit an audible sound (act 610) which is output for user experience (act 613), and an inaudible audio signal which will be detected and interpreted by the second device (as described in the acts presented earlier). The second device will then emit an audible sound (act 620) which is output for user experience (act 623), and an inaudible audio signal which will be detected and interpreted (act 622) by the first device. The two devices can send signals and execute instructions several times. In this manner, it will appear to the user that the first and second toys are having a conversation with one another. This conversation may be intelligible or unintelligible and may include visual, haptic, audio, or other types of output.

In some cases, the two devices can perform an initial calibration, registration, or pairing operation to determine which frequencies each device will use. For instance, the first device can send a sound wave to the second device informing the second device that the first device will communicate using a selected sound frequency. In some cases, the first device can also instruct the second device to use either the same frequency or a different frequency for any responses. The communication can then proceed in the manner described above.

In some embodiments, the first device can transmit a sound wave to the second device to pair with the second device. To complete the pairing process, the second device may send a response back to the first device informing the first device of a successful or failed pair. In some cases, the second device can use the same or a different frequency for its response.

The smart device can be configured to receive and respond to more than one audio signal simultaneously or consecutively. In this manner, when two devices are within proximity of each other, the smart device will have the capability to facilitate communication for more than one device.

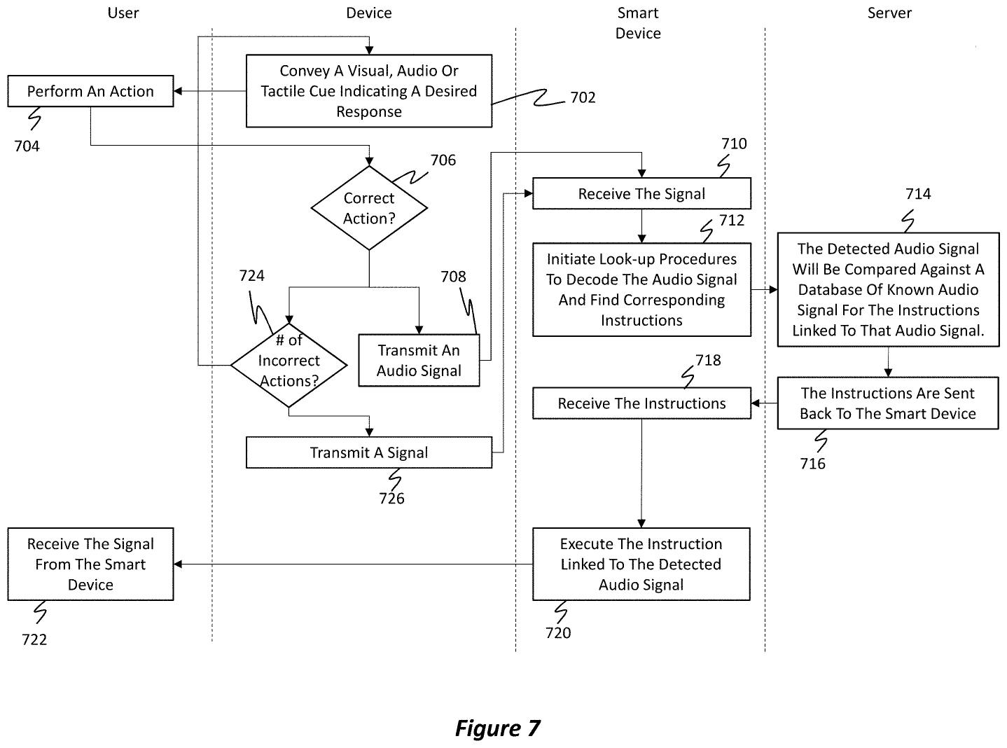

In another embodiment, illustrated in FIG. 7, the device can be programmed with conditional responses, and the smart device can provide feedback to the user resulting in a more interactive experience. The device can convey to the user through visual, audio, tactical, or via another cue a specific desired response (act 702). The user will then perform an action (act 704). The device detects the action and determines whether the action performed by the user was the correct action (act 706) for the cue that the device provided. If the user performs the correct action, the device will emit an audio signal (act 708) which will be detected by a smart device (act 710). After the smart device detects the audio signal, the smart device will initiate the look-up procedures to find corresponding instructions (act 712) using a database accessed on a server (act 714) and convey the instructions (act 716) back to the smart device (act 718), the smart device will then execute the instructions (act 720) which may include a cue to the user that the correct action was performed (act 722).

If, however, the user does not perform the correct action (act 704), the device will detect the input and determine that it was incorrect (act 706). After which the device will determine if the user has performed a predetermined number of consecutive incorrect responses (act 724). If the user has not, the device will convey the visual, audio, tactile, or other cue again (act 702) and the process will repeat from the beginning. If, however, the device determines that the user has performed the incorrect action consecutively for a predetermined number of times, the device will emit an audio signal which is linked to an instruction set that will help the user perform the correct action (act 726). This audio signal will be detected by the smart device and eventually the smart device will convey helpful output to the user.

For example, the toy might bark at the user because it intends to convey to the user that it wants to be pet on the head. If the user correctly pets the toy on the head (e.g., generally in act 704), the toy will emit an audio signal to the smart device which will result in the smart device playing an audio recording which says, “Your doggie likes that!” This conveys a message to the user that they have correctly responded to the toy's bark. However, if the user incorrectly tries to pet the tummy, the device will cue the user again with a second bark (e.g., thereby repeating act 702). If the user incorrectly pets the tummy again, the toy will emit an audio signal which will result in the smart device saying “I think your doggie wants a pet on the head.” This conveys a message to the user that they have incorrectly responded to the toy's bark and provides output to help the user perform the correct action. In this manner, the toy can control the smart device to provide information to help the user play with the toy.

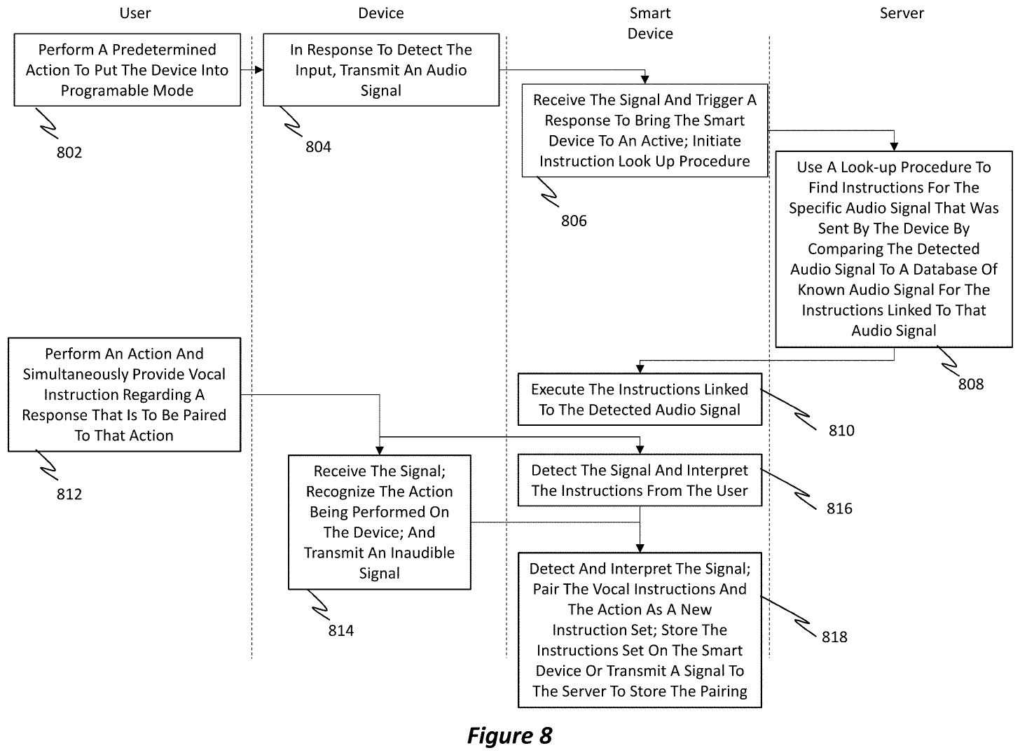

In another embodiment, illustrated in FIG. 8, the toy includes functionality for the user to program/correlate specific user inputs with certain audio files. For instance, a user can program certain audio keywords that are correlated with inputs at the toy, like tactile inputs received at the toy sensors, and that will be rendered/played (e.g., sent to the smart device) when the tactile inputs are later received/detected at the toy.

For example, the user is able to perform a predetermined act to put the toy into programmable mode (act 802). Subsequently, the device detects the input and then recognizes the action is intended to place the device in the programmable mode (act 804). The device then transmits an (in)audible signal to a smart device (i.e. an external device). The smart device receives the signal and then recognizes the (in)audible signal (act 806). Recognizing the signal effectively triggers a response from the smart device to bring the smart device to an active or “on” state. The smart device also initiates an instruction look up procedure. In some cases, the smart device and then interact with a server (act 808). Through these interactions, the smart device will use a lookup procedure to find instructions for the specific audio signal that was sent by the device. Such an operation may be performed by comparing the detected audio signal to a database of known audio signals for the instructions linked to that audio signal.

The smart device may then execute (act 810) the instructions linked to the detected audio signal. These instructions, in some cases, may include instructions to remain ready for further instruction from the user to program the device.

In some cases, the user performs an action and simultaneously provides vocal instructions to the smart device regarding the response the user would like paired to that action (act 812). For instance, the user might simultaneously squeeze the left paw of the toy and say “Alexa, turn off the light”. Here, the device can receive the signal and then recognize the action being performed on the device (act 814). In some cases, the device can also transmit an inaudible signal to the smart device. The smart device detects the audio and then interprets the vocal instructions from the user (act 816). Additionally, the smart device can pair the vocal instructions with the instruction to create a new instruction set (act 818). The new pairing is stored on the smart device or a signal is transmitted to the server to store the pairing. As an example, the toy can communicate the audio instruction, “Alexa, turn off the light” the next time that left paw is squeezed, in either an audible or inaudible analog signal. Then, Alexa (if connected to a correspondingly connected smart light device) can turn off the light.

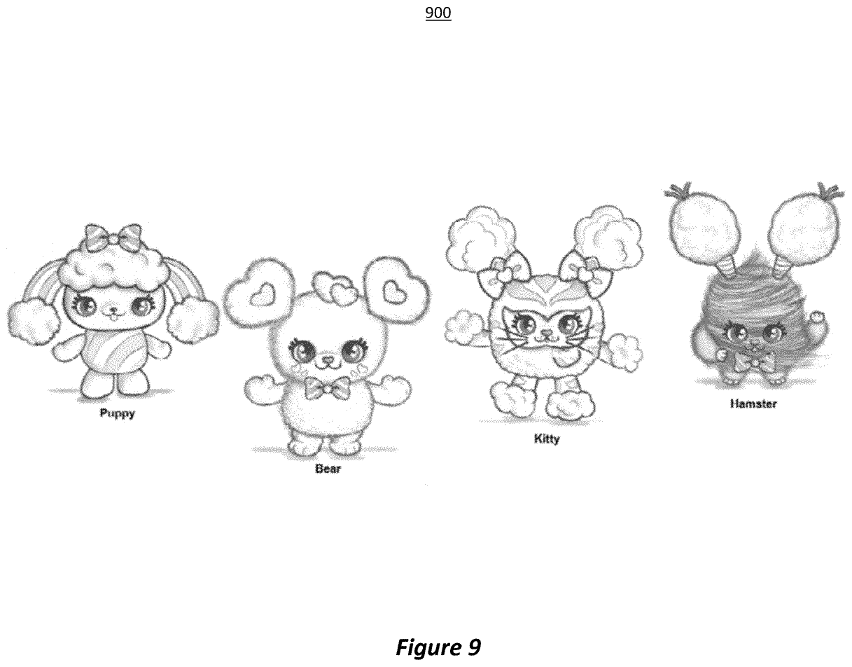

FIG. 9 illustrates non-limiting examples of plush toys 900 configured to implement at least some of the functionality described above, such as to interact with smart devices via audio signals and to detect user input that triggers the rendering of the audio signals. It will be appreciated that while the current illustration indicates that the toys are “plush,” it will be appreciated that the toys can be soft or hard. The toys can also be tools, learning devices, and/or other objects that are not considered children's toys.

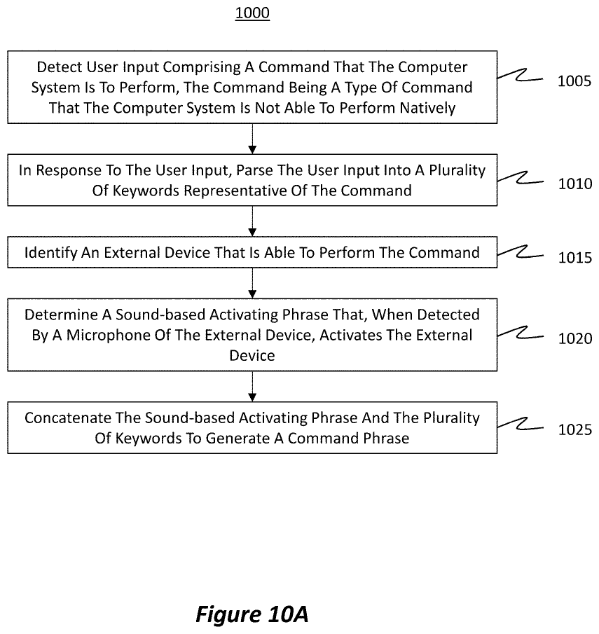

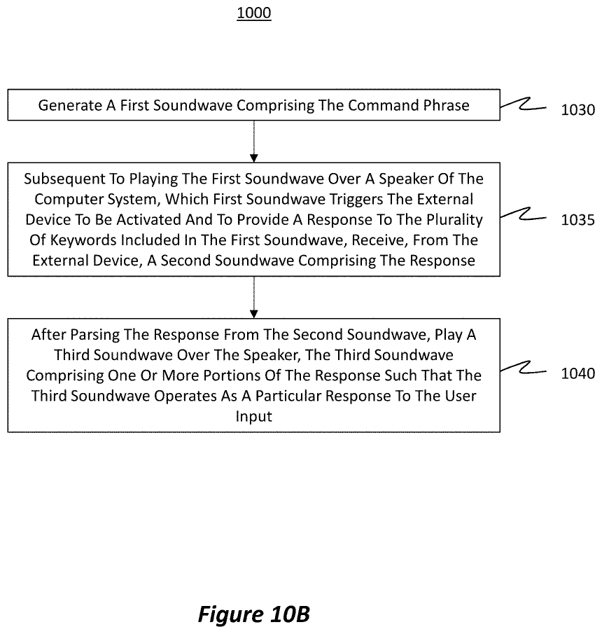

Attention will now be directed to FIGS. 10A and 10B, which illustrate a flowchart of an example method 1000 for enabling a master device (e.g., the toy described throughout this disclosure) to control a slave device (e.g., the external devices described through this disclosure). Initially, method 1000 in FIG. 10A includes an act (act 1005) of detecting user input comprising a command that the master device (i.e. a type of computer system) is to perform. The user input may be provided in numerous different ways. In some cases, the user input is received at a touch screen provided on the toy while in other cases the user input is audible input spoken by a user. In some cases, detecting the user input includes first (or initially) detecting activation of a push button on the toy and then second receiving the user input (e.g., after the push button has been activated). That is, the toy may not listen or detect user input until such time as a particular button on the toy is first depressed, manipulated, or otherwise activated.

The command is a type of command that the toy is not able to perform natively. For instance, a child may have asked the toy a specific question. The toy, however, may not have an answer to that question in its programming. That said, however, the answer can be obtained by querying the Internet. Therefore, when reference is made to the toy not being able to respond using its native abilities, the toy is required to obtain assistance from another device in order to connect to the Internet. Furthermore, the toy either does not have Internet connectivity (e.g., perhaps because the toy is out of range of a wireless Internet router or a cell tower for 3G, 4G, or 5G connection) or, alternatively, the toy does not include any kind of Internet interface such that the toy cannot natively respond to the command by itself.

In response to the user input, there is an act (act 1010) of parsing the user input into a plurality of keywords representative of the command. For instance, the toy is able to convert the user input into text and identify keywords from within the text that can represent the user input as a whole. These keywords may represent the semantics or meaning of the user input.

Subsequently, method 1000 includes an act (act 1015) of identifying an external device that is able to perform the command. Method 1000 also includes an act (act 1020) of determining a sound-based activating phrase that, when detected by a microphone of the external device, activates the external device (e.g., the sound-based activating phrase may be “Alexa” or something similar).

There is then an act (act 1025) of concatenating the sound-based activating phrase and the plurality of keywords to generate a command phrase. In some scenarios, concatenating the sound-based activating phrase and the keywords includes appending a time delay between the sound-based activating phrase and the keywords. Of course, this time delay may be set to any duration (e.g., between 1 second and 5 seconds or any other duration). In some cases, the command phrase is an interrogatory statement in which the external device is to provide an answer while in other cases the command phrase is a declarative statement to which the external device is to respond (e.g., to turn on lights or to play a song or to perform some other action).

Method 1000 continues in FIG. 10B. Specifically, there is an act (act 1030) of generating a first soundwave comprising the command phrase. In some cases, the frequency of this first soundwave is in an audible sound range or, alternatively, in an inaudible sound range.

Subsequent to playing the first soundwave over a speaker, which first soundwave triggers the external device to be activated and to provide a response to the plurality of keywords included in the first soundwave, method 1000 includes an act (act 1035) of receiving (or detecting), from the external device, a second soundwave comprising the response. In some cases, the first and second soundwaves use the same frequency while in other cases they use entirely different frequencies.

After parsing the response from the second soundwave, there is an act (act 1040) of playing a third soundwave over the speaker. The third soundwave comprises one or more portions of the response (e.g., the response may include numerous different words, some of which may be keywords while other words may be articles, transitions, prepositions, and so forth). These portions are particular keywords, and the toy can concatenate the particular keywords with additional keywords (e.g., articles, transitions, prepositions, etc.) that are selected by the toy for responding to the user input (e.g., to make the response less robotic in feeling and instead to provide a response that may have been worded by a human). Consequently, the third soundwave operates as a particular response to the user input. The third soundwave may be played using a preselected type of voice-like sound that is selected for responding to a user who provided the user input. For instance, the toy may be preprogrammed with a parent's voice to communicate with the child, or the toy may be preprogrammed with some other comforting voice. The third soundwave can be played using this particular voice.

In some cases, the frequency of the first soundwave is in an inaudible or audible sound range, the frequency of the second soundwave is in the inaudible or audible sound range, and the frequency of the third soundwave is in the audible sound range.

The embodiments disclosed above describe an application for toys; however, it will be appreciated that the scope of this disclosure also extends to other embodiments as well, such as, but not limited to, medical devices, communication, manufacturing, business, and/or other applications. By way of example, many users use medical or other devices to track health. The embodiments can be applied to communicate health data from a step counter, heart rate monitor, continuous glucose monitor, oxygen sensor, or any other medical device from the device to a smart device for any number of responses. The embodiments can beneficially reduce costs and make high quality medical care available to a wider audience. Further, there are applications in practically any industry where inanimate objects can very inexpensively communicate with smart objects through audible and inaudible sounds.

With regard to the foregoing, it will be appreciated that the disclosed methods may be practiced by a computer system including one or more processors and computer-readable media (e.g., hardware storage devices) such as computer memory. The computer memory and other storage devices of the disclosed computing systems may store computer-executable instructions that when executed by one or more processors of the computing systems cause various functions to be performed, such as the acts and other functionality recited in the disclosed embodiments. One will also appreciate how any one feature or attribute described in this disclosure may be combined or performed in conjunction with any other feature or attribute. As such, the features, attributes, and disclosed embodiments are not mutually exclusive; rather, the features may be interchanged or combined in any manner, without limitation.

Accordingly, it will be appreciated that embodiments of the disclosed invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer-readable storage media and transmission computer-readable media.

Physical computer-readable storage media includes RAM, ROM, EEPROM, CD-ROM or other optical disk storage (such as CDs, DVDs, etc.), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or transmit desired program code means in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RANI and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general-purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer system comprising:
one or more processors; and
one or more computer-readable hardware storage devices having stored thereon computer-executable instructions that are executable by the one or more processors to cause the computer system to:
detect user input comprising a command that the computer system is to perform, the command being a type of command that the computer system is not able to perform natively;
in response to the user input, parse the user input into a plurality of keywords representative of the command;
identify an external device that is able to perform the command;
determine a sound-based activating phrase that, when detected by a microphone of the external device, activates the external device;
concatenate the sound-based activating phrase and the plurality of keywords to generate a command phrase;
generate a first soundwave comprising the command phrase;
subsequent to playing the first soundwave over a speaker of the computer system, which first soundwave triggers the external device to be activated and to provide a response to the plurality of keywords included in the first soundwave, receive, from the external device, a second soundwave comprising the response; and
after parsing the response from the second soundwave, play a third soundwave over the speaker, the third soundwave comprising one or more portions of the response such that the third soundwave operates as a particular response to the user input.

2. The computer system of claim 1, wherein a frequency of the first soundwave is in an audible sound range.

3. The computer system of claim 1, wherein a frequency of the first soundwave is in an inaudible sound range.

4. The computer system of claim 1, wherein a frequency of the first soundwave is in an inaudible sound range, a frequency of the second soundwave is in the inaudible sound range, and a frequency of the third soundwave is in an audible sound range.

5. The computer system of claim 1, wherein the user input is audible input spoken by a user.

6. The computer system of claim 1, wherein concatenating the sound-based activating phrase and the plurality of keywords including appending a time delay between the sound-based activating phrase and the plurality of keywords.

7. The computer system of claim 6, wherein the time delay is between 1 second and 5 seconds.

8. The computer system of claim 1, wherein detecting the user input includes first detecting activation of a push button on the computer system and second receiving the user input after the push button has been activated.

9. The computer system of claim 1, wherein the one or more portions of the response are particular keywords, and wherein the computer system concatenates the particular keywords with additional keywords that are selected by the computer system for responding to the user input.

10. The computer system of claim 1, wherein the command phrase is an interrogatory statement to which the external device is to provide an answer.

11. The computer system of claim 1, wherein the command phrase is a declarative statement to which the external device is to respond.

12. The computer system of claim 1, wherein the third soundwave is played using a preselected type of voice-like sound that is selected for responding to a user who provided the user input.

13. The computer system of claim 1, wherein the user input is an interrogatory statement asking the computer system a question, and wherein the third soundwave provides an answer to the question.

14. The computer system of claim 1, wherein the computer system communicates with external devices only by sound.

15. The computer system of claim 1, wherein the computer system is included as a part of a plush toy.

16. The computer system of claim 1, wherein a frequency of the first soundwave and a frequency of the second soundwave are both in an inaudible sound range, and wherein the frequency of the first soundwave is below about 20 Hz and the frequency of the second soundwave is above about 20 KHz.

17. The computer system of claim 1, wherein a frequency of the first soundwave and a frequency of the second soundwave are both in an inaudible sound range, and wherein the frequency of the first soundwave is above about 20 KHz and the frequency of the second soundwave is below about 20 Hz.

18. The computer system of claim 1, wherein a frequency of the first soundwave and a frequency of the second soundwave are the same.

19. A method of enabling a master device to control a slave device, the method comprising:
detecting user input comprising a command that the computer system is to perform, the command being a type of command that the computer system is not able to perform natively;
in response to the user input, parsing the user input into a plurality of keywords representative of the command;
identifying an external device that is able to perform the command;
determining a sound-based activating phrase that, when detected by a microphone of the external device, activates the external device;
concatenating the sound-based activating phrase and the plurality of keywords to generate a command phrase;
generating a first soundwave comprising the command phrase;
subsequent to playing the first soundwave over a speaker of the computer system, which first soundwave triggers the external device to be activated and to providing a response to the plurality of keywords included in the first soundwave, receive, from the external device, a second soundwave comprising the response; and
after parsing the response from the second soundwave, playing a third soundwave over the speaker, the third soundwave comprising one or more portions of the response such that the third soundwave operates as a particular response to the user input.

20. One or more hardware storage devices having stored thereon computer-executable-executable instructions that are executable by one or more processors of a computer system to cause the computer system to:
detect user input comprising a command that the computer system is to perform, the command being a type of command that the computer system is not able to perform natively;
in response to the user input, parse the user input into a plurality of keywords representative of the command;
identify an external device that is able to perform the command;
determine a sound-based activating phrase that, when detected by a microphone of the external device, activates the external device;
concatenate the sound-based activating phrase and the plurality of keywords to generate a command phrase;
generate a first soundwave comprising the command phrase;
subsequent to playing the first soundwave over a speaker of the computer system, which first soundwave triggers the external device to be activated and to provide a response to the plurality of keywords included in the first soundwave, receive, from the external device, a second soundwave comprising the response; and
after parsing the response from the second soundwave, play a third soundwave over the speaker, the third soundwave comprising one or more portions of the response such that the third soundwave operates as a particular response to the user input.
